(19) United States
(12) Patent Application Publication
(10) Pub. No.: US 2007/0240580 A1
(43) Pub. Date: Oct. 18, 2007

(54) Disposable lid with filter for drink container

(76) Inventors: Donald W. Lusareta, Lee's Summit, MO (US); Ted O. McMillin, Parkville, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/403,073

(22) Filed: Apr. 12, 2006

(51) Int. Cl. A47J 31/44

(52) U.S. Cl. 99/279

(57) ABSTRACT

The present invention provides a disposable lid with filter for a drink container. The lid has an annular cover portion with an opening through which liquid can be consumed from the drink container. A container attachment portion of the lid is provided for removable association with the rim of the drink container in a snug, liquid-tight relation. A liquid permeable filter is positioned between the container attachment portion and the annular cover portion of the lid. The liquid permeable filter is positioned so as to intercept all liquid flowing from the container through the opening and hence to the mouth of the consumer.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates primarily to the making of tea and dispensing of the tea to a customer at a restaurant or at a take-out service where carry-out drink containers with disposable lids are used or at home where disposable lids are desired.

Recently, there has been a rapid increase of gourmet coffee shops which dispense gourmet coffee, tea and other beverages for on-premises or off-premises consumption in drink containers. The shops have catered to the coffee drinker by providing a wide variety of specialized coffee products including customized blends.

Many consumers in response to a perceived need to reduce their consumption of caffeine, are changing from coffee to tea, particularly herbal teas which are either very low in caffeine or completely caffeine free. However, the confirmed tea drinker generally finds a very limited variety of teas and only in the form of a tea bag, leaving the consumer with less than a gourmet experience.

While the processes of brewing tea and coffee have many similarities, the brewing of tea has traditionally been considered an art and hence, has not been, until the recent concern about caffeine, a part of fast-food or take-out services where drinks are dispensed in containers with disposable lids.

Prior to the creation of the tea bag, tea was brewed by pouring hot water over tea leaves in a pot and steeped until the tea reached desirable strength after which it was poured into a cup and consumed. Screens or strainers were provided to keep the tea leaves from escaping into the cup from which the consumer would drink the tea beverage. While the advent of the tea bag prevented the escape of tea leaves into the tea beverage, there are many disadvantages to the tea bag. For instance, the amount of tea leaves present in the bag is determined exclusively by the tea bag manufacturer. Tea drinkers vary in their desires for strength of the tea and the flavor of the tea. In fact, teas offer a much wider range of essences and flavors than do coffees.

Many tea drinkers are acutely aware of environmental problems and, for such consumers, there is a negative reaction to bleached papers used in tea bags. Furthermore, the use of strings and staples to facilitate the placing of the tea bag in the cup creates problems in the disposition of such products.

Elimination of the string and staples requires the server to use tongs to place the tea bag in the cup for sanitation reasons.

The foregoing disadvantages associated with tea bags are exacerbated when the beverage is sold “to go”. If the consumer tries to remove the bag because it interferes with the opening through which the tea flows, it may require the consumer to open the lid in order to remove the bag or place the bag in a certain position thus subjecting the consumer to possible injury due to the high temperature of the water.

The foregoing aspects of the prior art practices argue strongly for using brewing methods other than those involving tea bags and conventional container lids. The present invention, in several embodiments described below, avoids or eliminates some of the disadvantages related to use of tea bags and other brewing methods requiring strainers and the like. The present invention also overcomes some of the difficulties and disadvantages faced by lids for beverages, as those lids are conventionally constructed in the prior art. Yet the present invention also can be used with bagged tea or other pre-charged infusions or pre-charged brewed beverages such as coffee bags and the like.

Bulk or “loose” tea is perceived to be of higher quality than bagged tea.

Bulk tea requires less space per serving than the bagged tea and has virtually no waste to be disposed of in comparison to the bagged tea which has the envelopes containing the tea bags, the box in which the envelopes are shipped and the bag itself. In order to serve a popular market successfully, the vendor should be able to offer several varieties of black tea, several varieties of green tea and a significant number of herbal teas along with a number of flavoring enhancers or additives. These provide at least 10 or 20 varieties of teas and flavoring products, all of which are available at a lower cost in bulk, “loose” form which can be shipped and stored in much smaller containers. The use of jars or cans or the like, is particularly desirable because they can be resealed thus preserving freshness.

Besides tea, there are other hot beverages which can benefit from the present invention. For example, there are flavored coffees which must be made and served in quantity rather than to the customer's individual taste. Like tea, the coffee can be provided in bulk so that the customer can pick and choose a mixture of flavors to provide his or her customized hot drink.

In the manufacture of the tea bags, the tea leaves tend to become crushed and broken thereby restricting the circulation of the leaves in the hot water. Most tea bag manufacturers tend to use a lower quality of tea leaves.

Furthermore, there is the problem of the disposal of the tea bag. Tea bags are generally available in only one or two sizes as are the size of the containers thus limiting the strength of the tea drink provided.

Tea drinkers of today have reached a degree of sophistication where they are desirous of customized blends of tea leaves to provide a particular essence and flavor which is not available in the array of pre-manufactured tea bags. To serve this need, shops may have canisters of many different tea leaves to provide the consumer with the opportunity to experiment with blends until the desired essence and flavor is present. But simply placing the tea leaves in a drink container and adding hot water leaves the tea leaves loose in the bottom of the drink container. Many tea drinkers have a variety of tea leaves at home so as to provide a customized flavor and essence. However, it is not always advantageous to brew tea the old fashioned way.

The present invention provides a disposable lid with filter for a drink container to overcome the problem of loose tea leaves or any other insoluble matter not desirous to consume from reaching the mouth of the drink consumer.

### BRIEF SUMMARY OF THE INVENTION

Briefly stated, the present invention provides a disposable lid with filter for a drink container. The lid is comprised of an annular cover portion having an opening through which liquid can be consumed from the drink container. A container attachment portion of the lid is provided for removable association with the rim of the drink container in a snug, liquid-tight relation. A liquid permeable filter is positioned between the container attachment portion and the annular cover portion of the lid. The liquid permeable filter is positioned so as to intercept all liquid flowing from the container through the opening and hence to the mouth of the consumer.

The liquid permeable filter may be comprised of a mesh material, a porous material, a disk with holes and/or slits to permit the flow of liquid there through, and any other suitable filter which will remove undesirable solid substances from the liquid in the container as the liquid flows from the container through the opening in the annular cover portion of the lid.

When utilizing the lid of the present invention, the typical tea consumer merely places the desired tea leaves into the liquid container, adds hot water in the desired amount, allows the tea to steep for an appropriate amount of time, places the lie with filter on the liquid container and consumes the brewed tea beverage at leisure being assured that no tea leaves slip through the opening through which the beverage is consumed.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a top perspective view of one embodiment of the present invention;

FIG. 2 is a bottom perspective view of the lid of the embodiment of FIG. 1;

FIG. 3 is a side perspective section view along line 3-3 of FIG. 1;

FIG. 4 is a top perspective view of another embodiment of the present invention;

FIG. 5 is a bottom perspective view of the embodiment of FIG. 4;

FIG. 6 is a side perspective section view along line 6-6 of FIG. 4; and

FIG. 7 is a side perspective section view of a multiplicity of the embodiment of FIG. 6.

Corresponding reference numerals indicate corresponding parts throughout the several figures of the drawings.

### DETAILED DESCRIPTION OF THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

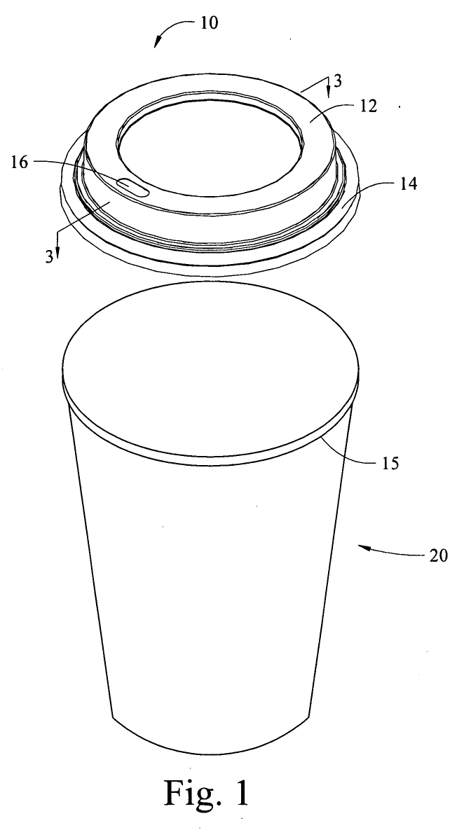

FIG. 1 depicts a typical drink container 20 sold at coffee shops, fast-food restaurants, diners and many other food and drink businesses which sell eat-in or carry-out food and accompanying drink containers as well as a cup or glass from the home kitchen. A disposable lid 10 depicted in FIG. 1 appears to be typical of lids for drink containers. The lid 10 has an annular cover portion 12 which is provided with an opening 16. The opening 16 allows liquid to be consumed from the container 20 in a conventional manner. The lid 10 also has a container attachment portion 14 for removable association with the rim 15 of the container 20 in a snug, liquid-tight relation.

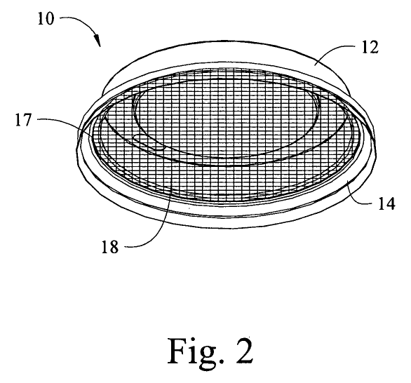

FIG. 2 depicts the under side of the lid 10 showing a filter 18 positioned across the area of the interior of the lid 10 so as to intercept any liquid flowing from the container 20 through the opening 16 of the lid 10. It is preferred that the position of the filter 18 within the lid 10 is such that the filter 18 is a sufficient distance from the opening 16 that tea leaves or undesirable solid substances in the liquid container 20 will not jam against the filter 18 in a manner such as to impede the flow of liquid from the container 20 through the opening 16. The filter 18 is attached to the inside 17 of the lid 10 in a suitable manner such as with the use of an adhesive, of heat sealing or any other suitable means of attaching the filter 18 to the inside 17 of the lid 10.

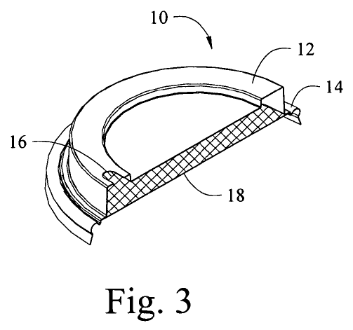

FIG. 3 depicts a side perspective section view along line 3-3 of FIG. 1. This figure illustrates a suggested positioning of the filter 18 with respect to the container attachment portion 14, the opening 16 and the annular cover portion 12 of the lid 10. In this embodiment, the filter 18 is somewhat taut thus keeping the filter 18 from engaging the opening 16 of the lid 10.

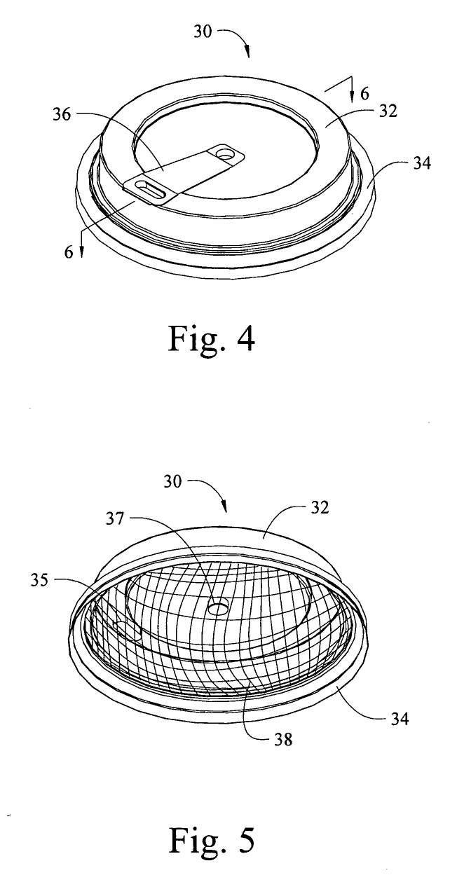

FIG. 4 is a top perspective view of another embodiment of the present invention. The disposable lid 30 has a swivel tab 36 which when lifted provides an opening 35 (see FIG. 4) through which liquid can be consumed from the container 20. The swivel tab 36 swivels about a pivot 37 permitting the opening 35 to be resealed to prevent spillage from the container 20 when the consumer is not drinking from the container 20. The lid 30 has an annular cover portion 32 and a container attachment portion 34 to allow the lid 30 to be separated from the rim 15 of the container 20, if desired.

FIG. 5 depicts a bottom perspective view of the lid 30 of FIG. 4. The filter 38 is a mesh material which rather than being taut is relaxed so as to allow the stacking one on another of a multiplicity of lids 30 for the convenience of storage when shipping and when being used in a shop.

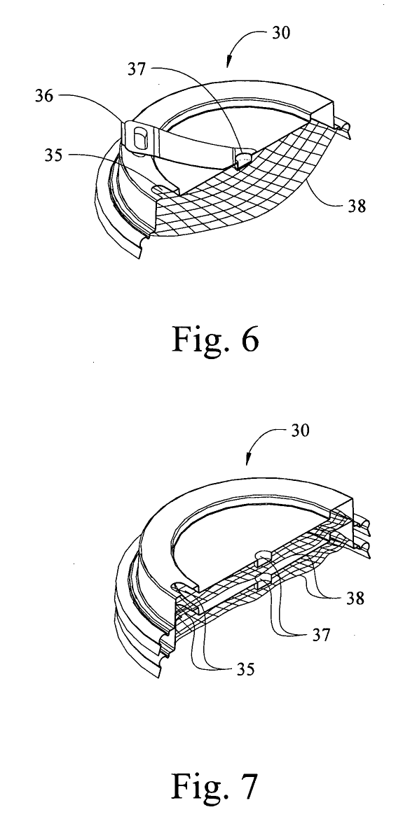

FIG. 6 illustrates a side section view along line 6-6 of FIG. 4 to illustrate the more relaxed filter 38 to allow stacking of the lids for shipping, storage and when in a dispensing bin at a shop. Even though the filter 38 is relaxed, it is preferred that the filter 38 not reach the opening 35 when the drink is being consumed from the container 20 to prevent a jam of tea leaves or other solid material in the drink container 20. The swivel top 36 can be moved around the pivot 37 to allow closure of the lid 30 to prevent spillage when the drink is not being consumed.

FIG. 7 is a side section view along line 6-6 of FIG. 4 of two lids 30 in a nesting configuration thereby allowing compaction for the purposes of shipping and storage of the lids 30.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A disposable lid with filter for a drink container comprising an annular cover portion having an opening through which liquid can be consumed from the drink container, a container attachment portion for removable association with the rim of the drink container in a snug, liquid-tight relation and a liquid permeable filter positioned between the container attachment portion and the annular cover portion.

2. The lid of claim 1 wherein the liquid permeable filter is positioned to intercept all liquid flowing from the container through the opening.

3. The lid of claim 1 wherein the liquid permeable filter is comprised of a flexible mesh material.

4. The lid of claim 3 wherein the flexible mesh material is affixed to an inside wall of the lid and positioned to extend from the wall inwardly.

5. The lid of claim 4 wherein the flexible mesh material is taut.

6. The lid of claim 4 wherein the flexible mesh material is relaxed.

7. The lid of claim 1 wherein the liquid permeable filter is a liquid permeable disk suitably positioned to intercept all liquid flowing from the container through the opening in the annular cover portion of the lid.

8. The lid of claim 1 wherein a swivel tab is provided which when lifted provides an opening through which liquid can be consumed and when replaced to its original position, closes the opening.
